(19) United States
(12) Patent Application Publication
(10) Pub. No.: US 2006/0062153 A1
(43) Pub. Date: Mar. 23, 2006

(54) Customer service system of embedded system device and metohd thereof

(76) Inventors: Fan-Sheng Lin, Taipei City (TW); Sung-Chin Shen, Taipei City (TW); Chun-Hsien Lee, Taipei City (TW)

Correspondence Address: RABIN & BERDO, P.C.;Suite 500, 1101 14 Street, N.W., Washington, DC, 20005, US

(21) Appl. No.: 11/044,034

(22) Filed: Jan. 28, 2005

(30) Foreign Application Priority Data
Sep. 21, 2004 (TW) 93128637

(51) Int. Cl. H04L 12/26

(52) U.S. Cl. 370/241

(57) ABSTRACT

An embedded system device customer service system and operation method thereof, which is based on an instinctive service enabling idea, automatically actuates the network function of a computer executable interface and connects the embedded system device to a remote customer service system after an embedded system device is physically connected to the computer executable interface also with network function. Therefore, a logic channel between the embedded system device without network function and the customer service system is built up to control the embedded system device and to transmit/receive a system customer service information without user's operation. In the preferred embodiment, the embedded system device is physically connected to the computer executable interface via a Universal Serial Bus (USB) interface. Accordingly, even if the embedded system device loses its own power, a real-time online customer service can be still performed.

This application claims the benefit of Taiwan Patent Application No. 93128637, filed on Sep. 21, 2004, which is hereby incorporated by reference for all purposes as if fully set forth herein.

### BACKGROUND OF THE INVENTION

1. Field of Invention

The invention relates to a customer service system and method, and more particularly to a system and method for an embedded system device that can connect to a computer executable interface and then perform an online customer service with a remote customer service system via the INTERNET.

2. Related Art

FIG. 1 is a conventional customer service of the embedded system device. When the user 10 finds an abnormal condition in the operation of the embedded system device 100, usually communicates with a remote representative 30 or a customer service system 40 directly via a communication tool 20 such as real-time instant messaging software or a telephone to request for the diagnosis of the embedded system device 100. The diagnosis result is then provided via the communication tool 20 to the user 10 to manually repair the embedded system device 100.

However, such a conventional mode of the customer service has several problems.

First, the user 10 cannot get the customer service information anytime. Processes of building a communication channel between the user 10 and the customer service are complicated and inconvenient. Actually, customer service information should be available anytime for the user 10 to acquire a complete customer service. Therefore, it is an additional burden for the user 10 to remember and to retrieve the customer service information. Even after the customer service information is obtained, there sill have many procedures for the user 10, such as connecting to the customer service system and talking on the telephone, to build up the communication channel.

Second, the user 10 often lacks for professional skills in this field, so the remote customer service representative 30 cannot control the conditions of the embedded system device 100 exactly, resulting in lower efficiency. Besides, even if the communication channel has been built up, the abnormal condition occurring in the embedded system device 100 still cannot be completely reflected and thus cannot be exactly diagnosed. Furthermore, the user 10 must do the repairing according to the information from the remote customer service. These are all difficult for the user 10 who lacks professional knowledge.

Finally, a customer service required user participation, restricting the operation modes and ranges of the customer service. Since the user 10 usually has insufficient professional skills, many customer service such as software updating, product registration and activating service, which require specific operations, cannot be processed. Thereby, the development of customer service of the embedded system device 100 is obstructed.

Therefore, there is a need to provide a customer service operation model that allows the remote customer service to respond promptly to problems of the embedded system device 100 without the participation of the user 10, thus increasing customer service efficiency and coverage.

### SUMMARY OF THE INVENTION

The invention is about a customer service system of an embedded system device and the method thereof, which is based on an instinctive service enabling idea, automatically actuates the network function of a computer executable interface and connects the embedded system device to a remote customer service system after an embedded system device is physically connected to the computer executable interface, which is also provided with network function. Therefore, a logic channel between the embedded system device without network function and the customer service system is built up without user's participation to finish the real-time online customer service.

In order to achieve the mentioned objectives, a customer service system of an embedded system device according to the invention includes: (1) an embedded system device, with an embedded system controller, a memory, a device transmission interface and a customer service client program; (2) a computer executable interface, including a host transmission interface, a first network transmission interface and a system control interface; and (3) a customer service system, including a second network transmission interface, a customer service server program and a customer service system control interface.

A method of operating the customer service system of the embedded system device according to the invention includes the following steps: (1) connect an embedded system device to a host transmission interface of a computer executable interface physically, and then generate a system control interface in the computer executable interface; (2) execute a customer service client program of the embedded system device to drive a first network transmission interface of the computer executable interface to connect with a second network transmission interface of the customer service system via the INTERNET; and (3) receive an operational command from the computer executable interface or the customer service system to control a embedded system controller of the embedded system device and to transmit/receive a system customer service information.

In a preferred embodiment, the embedded system device is physically connected to the computer executable interface via a Universal Serial Bus (USB) interface. Accordingly, even if the embedded system device loses its own power, a real-time online customer service can be still performed.

Due to the direct connection between the embedded system device and the customer service system, it is easy to build up the customer service communication channel. Without the manual operation of users, customer service efficiency is improved. Furthermore, the customer service system can operate the embedded system device directly. Therefore, the content of the customer service can be made more versatile.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic view of the operation of a conventional customer service system;

FIG. 2A is a schematic view of the operation of a customer service system according to the invention;

FIG. 2B is a logic schematic view of the operation of a customer service system according to the invention;

FIG. 3 is a block diagram of a customer service system according to the invention;

FIG. 4 is a flow chart of a method of operating the customer service system according to the invention;

FIG. 5 is a detailed flow chart of a method of operating the customer service system according to the invention;

FIG. 6 is a detailed flow chart of a diagnosis procedure of an embedded system device according to the invention; and

FIG. 7A˜FIG. 7C are schematic views of the operation of the diagnosis procedure of the embedded system device according to the invention.

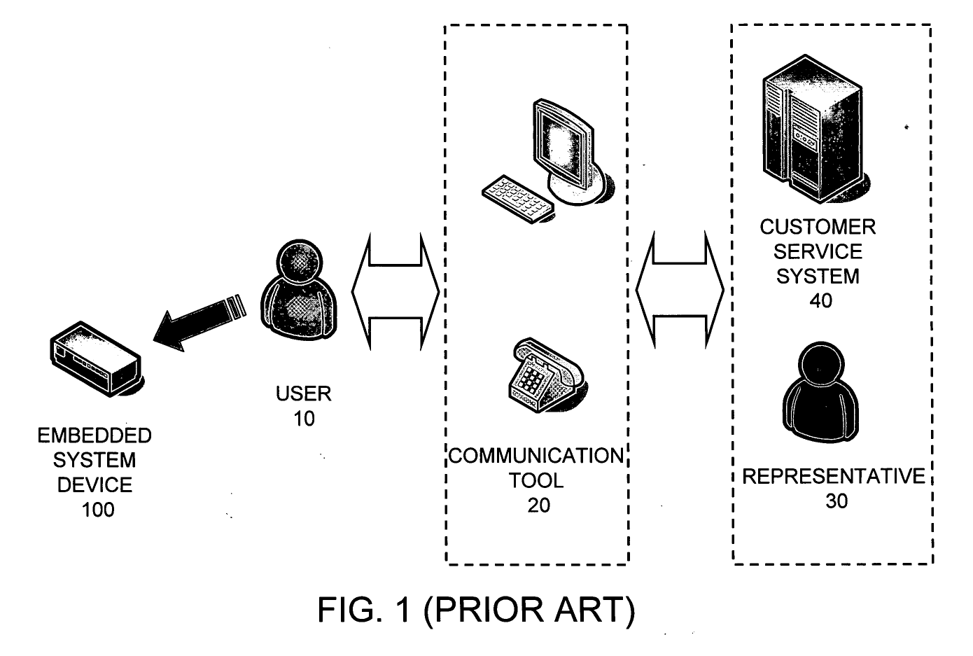

### DETAILED DESCRIPTION OF THE INVENTION

Reference will now be made in detail to an embodiment of the present invention, example of which is illustrated in the accompanying drawings. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

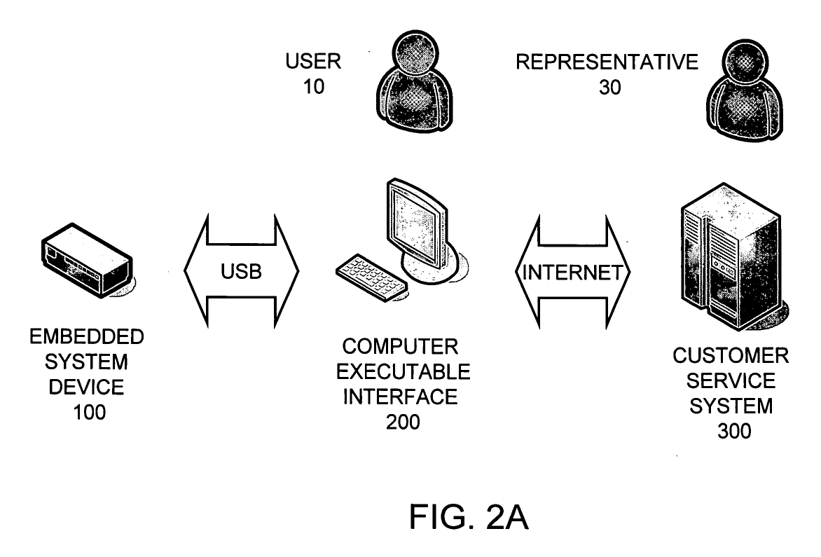

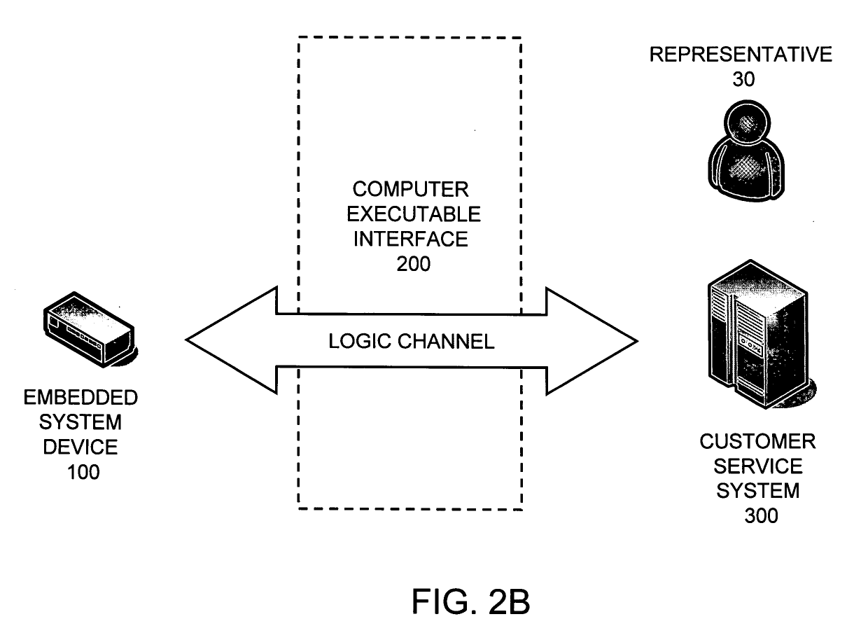

The invention provides an embedded system device 100 and a method thereof, which is based on an instinctive service enabling idea. Referring to FIG. 2A, when a user 10 finds the embedded system device 100 is in an abnormal condition (or needs other remote customer services), only the embedded system device 100 needs to be physically connected to a computer executable interface 200. That is, the embedded system device 100 and the computer executable interface 200 are connected via a specific transmission interface such as a USB interface. The embedded system device 100 automatically actuates the network function of the computer executable interface 200 so that the embedded system device 100 connects the computer executable interface 200 to the customer service system 300 via the INTERNET. The user 10 uses a system control interface 220 generated on the computer executable interface 200 by the embedded system device 100 to request any customer service from a customer service system 300. Alternatively, a real-time instant messaging software is used by the user 10 with a representative 30 for online real-time communicating. Thereby, the customer service of the embedded system service 100 can be achieved without user's operation even if the embedded system device 100 is out of network function.

Referring to FIG. 2B illustrating the mentioned instinctive service enabling idea. A logic channel between the embedded system device 100 and the customer service system 300 is built up by the computer executable interface 200. That is, the embedded system device 100 is virtually connected to the customer service system 300 to conduct the customer service. This way is convenient for both the user 10 and the representative 30.

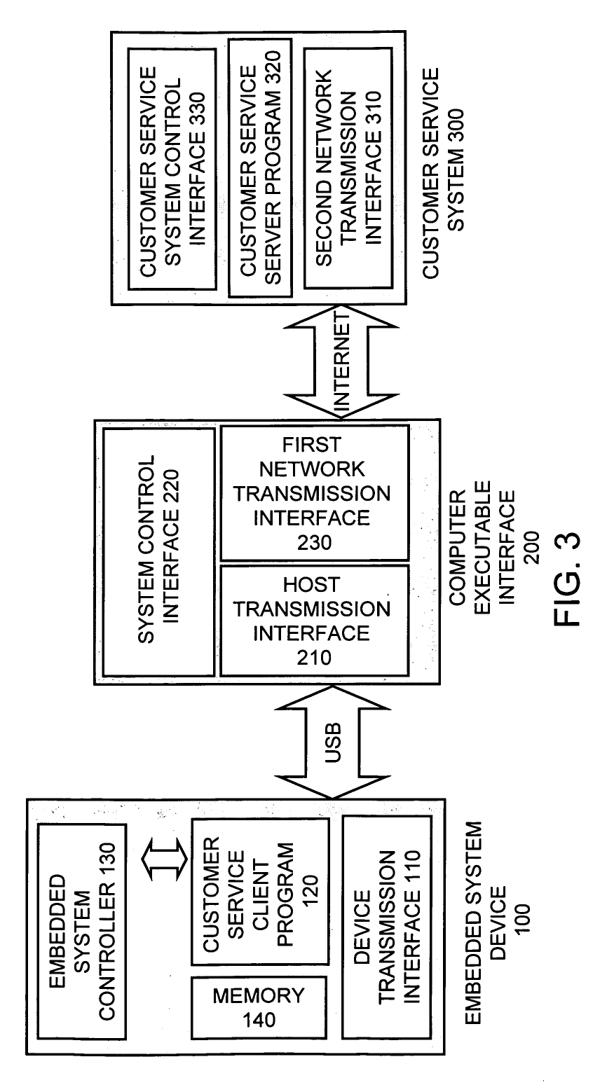

Referring to FIG. 3, the customer service system 300 of the embedded system device 100 according to the invention includes (1) an embedded system device 100; (2) a computer executable interface 200; and (3) a customer service system 300. The function and operation of the system are given in details as follows.

The embedded system device 100 includes a device transmission interface 110 that is used to physically connect to a host transmission interface 210 of the computer executable interface 200. A customer service client program 120 automatically activates and generates a system control interface 220 on the computer executable interface 200 when the device transmission interface 110 connects to the computer executable interface 200, so that an embedded system controller 130 is controlled via the system control interface 220 and the system customer service information is transmitted and received. The embedded system controller 130 is core operation unit of the embedded system device 100. When the user 10 executes an operation command, the embedded system controller 130 performs a self-diagnosis procedure to generate embedded system configuration information and save the diagnosis result in the memory 140. The memory 140 serves to store various system customer service information, such as product registration information, software version information, embedded system configuration information, embedded system record information, service actuating information, and customer service log information.

The computer executable interface 200 is physically connected to the embedded system device 100, and then connected to the customer service system 300 via the INTERNET. Therefore, specific transmission interface and network function are the basic elements of the computer executable interface 200. The computer executable interface 200 includes at least a host transmission interface 210 physically connected to the embedded system device 100; a system control interface 220 generated by the customer service client program 120 for the control of the embedded system controller 130 and transmission/reception of the customer service information after the computer executable interface 200 physically connects to the embedded system device 100; and a first network transmission interface 230 connecting to the customer service system 300 via the INTERNET.

The customer service system 300 connects to the computer executable interface 200 via the INTERNET. The customer service system 300 includes a second network transmission interface 310 connecting to the first network transmission interface 230 according to driving operation from the customer service client program 120; a customer service server program 320 serving to communicate the customer service client program 120 through the system control interface 220 to control the embedded system controller 130, and to transmit/receive system customer service information; a customer service system control interface 330 communicating with the customer service server program 320 to allow the representative 30 to control the embedded system controller 130 and process the system customer service information, or communicate with the user 10 directly. For example, a real-time instant messaging procedure is actuated via the system control interface 220 to provide mutual communication between the user 10 and the representative 30 in the form of texts, voice and images.

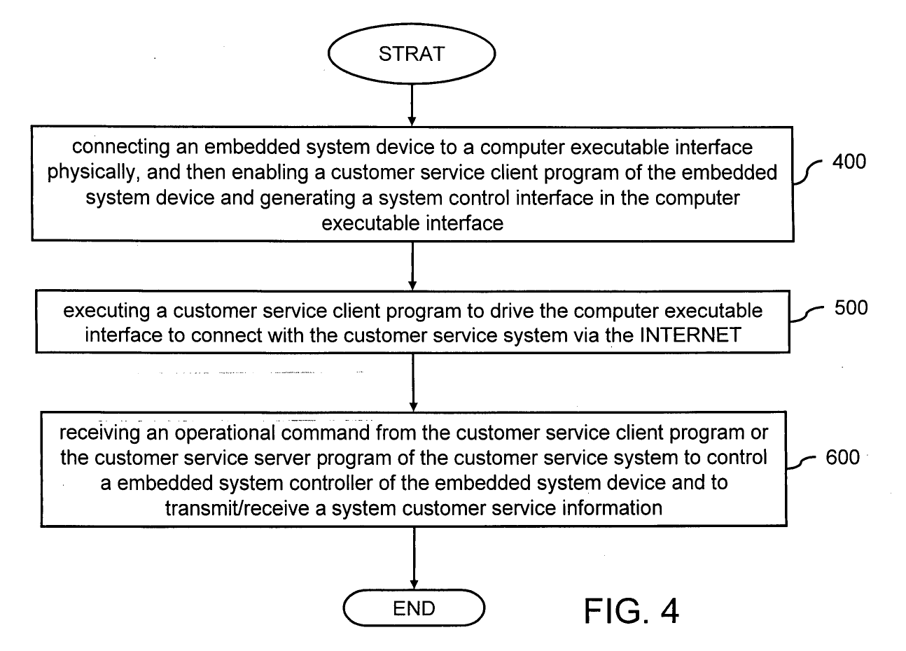

FIG. 4 is a flow chart of the customer service system 300 of the invention. The customer service system 300 is operated according to the following steps.

The device transmission interface 110 of the embedded system device 100 connects to the host transmission interface 210 of the computer executable interface 200 so that the embedded system device 100 physically connects to the computer executable interface 200. Then, the customer service client program 120 of the embedded system device 100 automatically generates the system control interface 220 in the computer executable interface 200 (step 400).

By automatically driving from the customer service client program 120, the first network transmission interface 230 of the computer executable interface 200 connects to the second network transmission interface 310 of the customer service system 300 via the INTERNET (step 500).

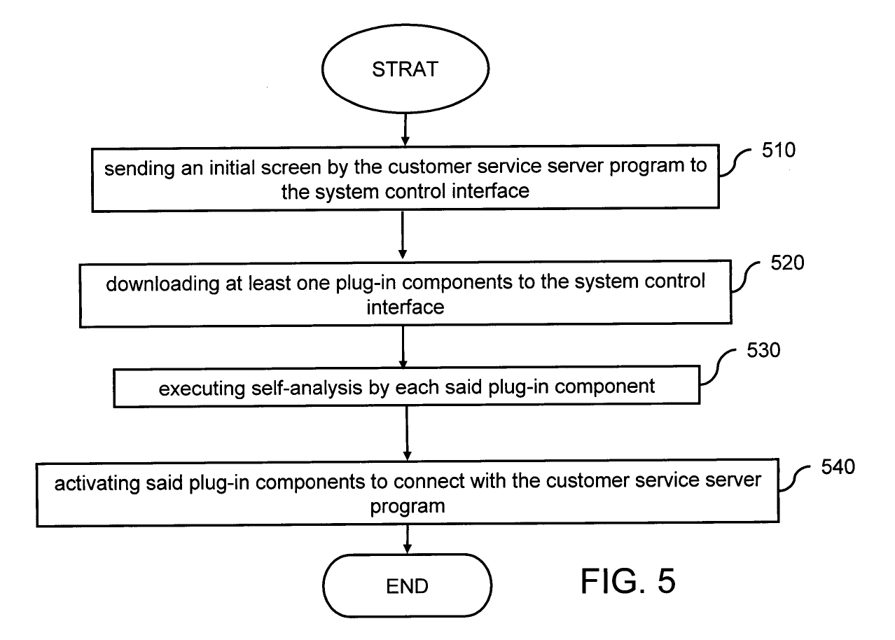

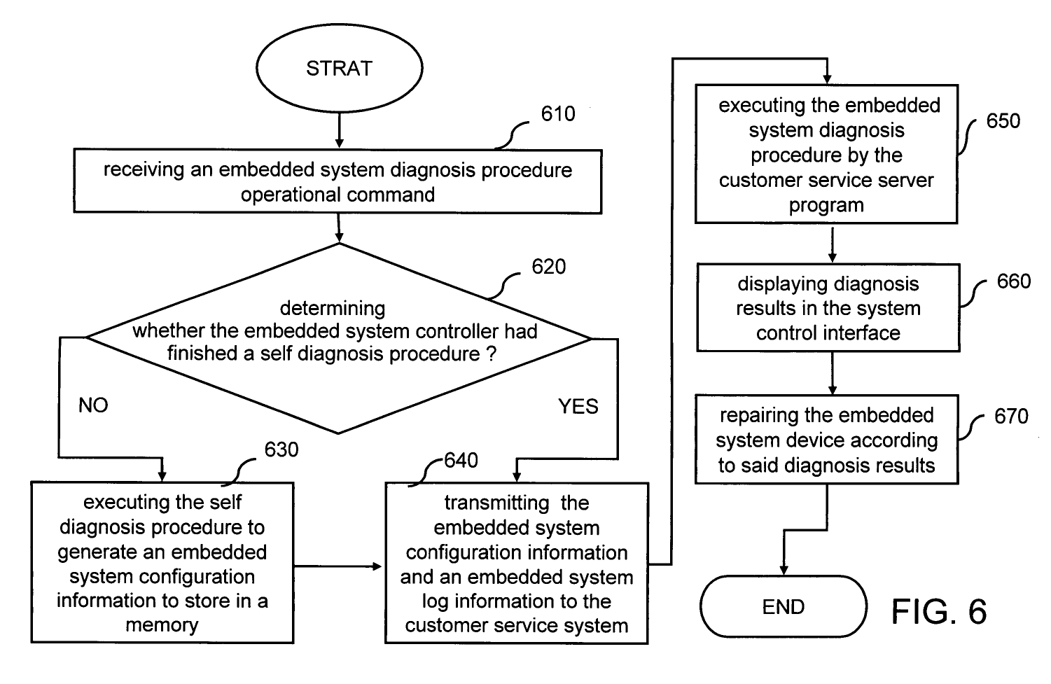

FIG. 5 illustrates the detailed initial processes between the system control interface 220 in the computer executable interface 200 and the customer service server program 320 of the customer service system 300 after network connection.

The customer service server program 320 transmits an initial screen to the system control interface 220 (step 510). The customer service server program 320 downloads required plug-in components to the system control interface 220 (step 520) after displaying the initial screen. Then, the plug-in components execute a self-diagnosis procedure (step 530). When the self-diagnosis is finished and confirmed, the plug-in components automatically activate and complete the connection with the customer service server program 320 (step 540).

After the plug-in components connect to the customer service server program 320, an operational command is received from the computer executable interface 200 or the customer service system 300. The customer service client program 120 of the embedded system device 100 and the customer service server program 320 of the customer service system 300 execute the control of the embedded system controller 130 and the transmission/reception of the system customer service information. The system customer service information, such as product registration information, software version information, embedded system configuration information, embedded system record information, service actuating information, and customer service log information, is saved in the memory 140 (step 600).

The operational command varies with the requirements for different system control demands. For example, the user 10 can activate the real-time instant messaging procedure in the system control interface 220 by executing a specific operational command to communicate on-line with the representative 30 through the customer service system control interface 330. Alternatively, while the embedded system controller 130 is being controlled, the embedded system controller 130 can execute the self-diagnosis procedure according to the other specific operational commands to generate and store the embedded system configuration information in the memory 140. The content and the types of the system configuration information are not limited and are well known in the art.

In the preferred embodiment of the invention, the embedded system device 100 is physically connected to the computer executable interface 200 via the USB interface. Therefore, even if the embedded system device 100 is out of network function and its own power, a real-time online customer service operation of the embedded system device 100 still can be performed by using the network function of the computer executable interface 210 and the USB power from the host transmission interface 210.

FIG. 6 illustrates the diagnosis procedure executed on the embedded system device 100 according to the preferred embodiment of the invention.

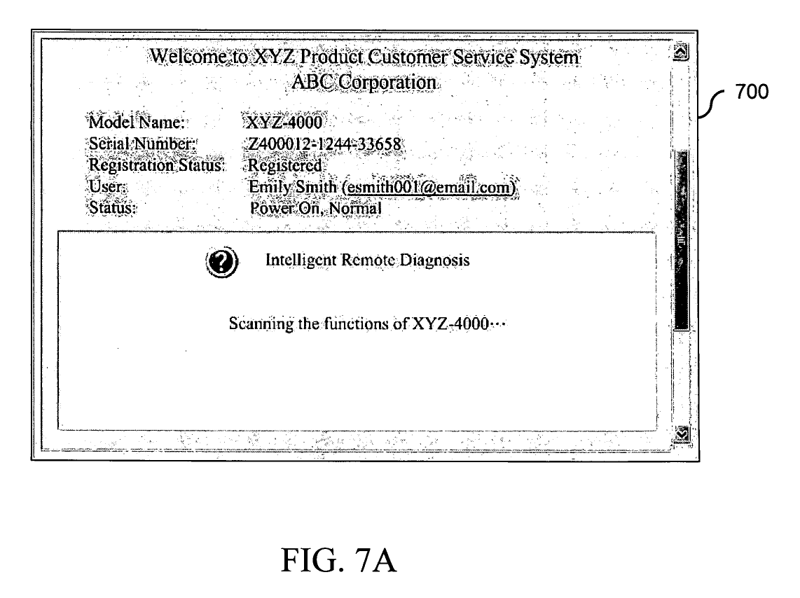

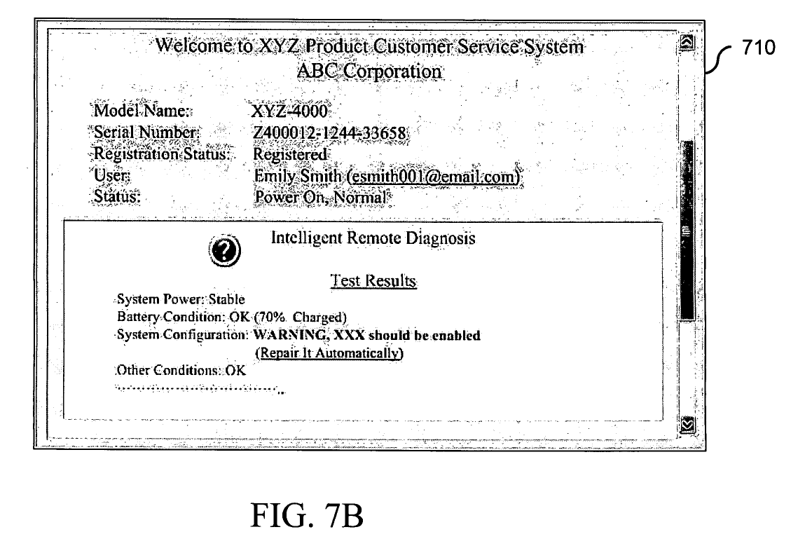

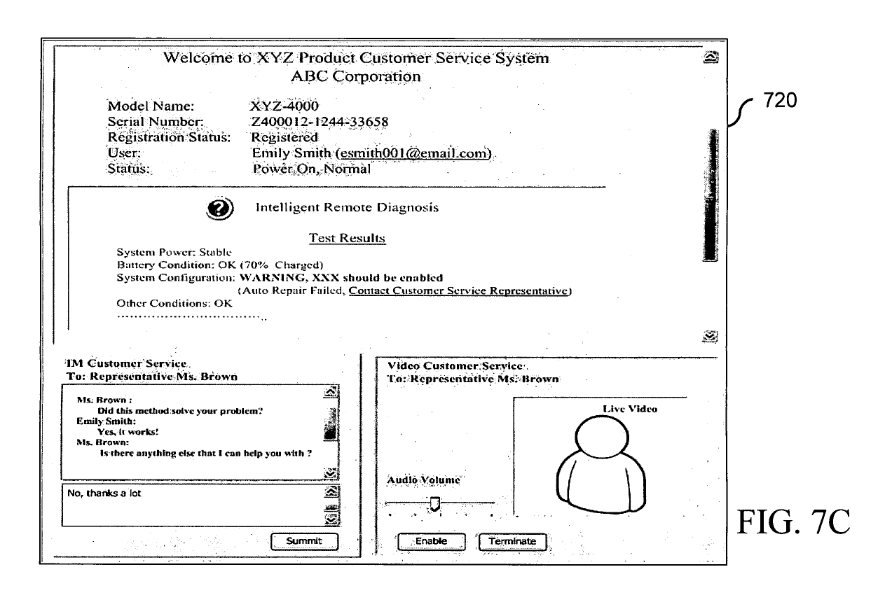

After the embedded system device 100 connects to the customer service system 300 via the computer executable interface 200, the user 10 can execute an operation command such as “embedded system diagnosis procedure operation command” to conduct the diagnosis of the embedded system device 100 via the system control interface 220 of the computer executable interface 200, as shown the screen 700 in FIG. 7A. The customer service server program 320 receives the embedded system diagnosis procedure operational command (step 610). The customer service server program 320 requests from the customer service client program 120 for the embedded system configuration information and the embedded system record information. The customer service client program 120 will determine whether the embedded system configuration information and the embedded system record information exist in the memory 140 of the embedded system device 100 (step 620). If exist, the embedded system configuration information and the embedded system record information are transmitted to the customer service system 300 (step 640). Otherwise, if none of the embedded system configuration information and the embedded system record information exists (means that the embedded system controller 130 has not finished the self-diagnosis procedure), then ask the embedded system controller 130 to execute the self-diagnosis procedure to regenerate the embedded system configuration information in the memory 140 (step 630). Then go to step 640. The customer service client program 120 transmits the embedded system configuration information and the embedded system record information to the customer service system 300. The embedded system configuration information and the embedded system record information received by the customer service system 300 are used to execute the embedded system diagnosis procedure by the customer service server program 320 (step 650). The whole diagnosis procedures are displayed via the customer service system control interface 330 for representative 30. All the diagnosis and processing results are displayed via the system control interface 220 (step 660), as shown the screen 710 in FIG. 7B. Finally, repairing of the embedded system is performed according to the feedback diagnosis results (step 670). The user 10 also can manually operate according to the diagnosis results, or the representative 30 can give an operational command via the customer service system control interface 330 to control the customer service client program 120 by the customer service server program 320 according to the diagnosis results to achieve the goal of automatic repairing without user's operation. Of course, the user 10 can also manually actuate the real-time instant massage procedure by selecting a specific operational command to communicate online with the remote representative 30, as shown the screen 720 in FIG. 7C.

The invention can be applied widely in service enabling, firmware updating, product registration, security control, technical support, and the like.

It will be apparent to the person skilled in the art that the invention as described above may be varied in many ways while nevertheless remaining within the spirit and scope of the invention as defined in the following claims.

What is claimed is:

1. A customer service system of an embedded system device, comprising:
a computer executable interface, comprising:
a host transmission interface;
a first network transmission interface; and
a system control interface;
an embedded system device, physically connecting to the computer executable interface, the embedded system device comprising:
an embedded system controller;
a memory storing at least one system custom service information;
a device transmission interface physically connecting to the host transmission interface; and
a customer service client program, which activates when connecting to the computer executable interface and generates the system control interface on the computer executable interface, controls the embedded system controller via the system control interface and transmitting/receiving of the system customer service information; and
a customer service system, connecting to the computer executable interface via the INTERNET, the customer service system comprising:
a second network transmission interface, connecting to the first network transmission interface according to the driving of the customer service client program;
a customer service server program, communicating with the customer service client program via the system control interface, controlling the embedded system controller and transmitting/receiving the system customer service information; and
a customer service system control interface, communicating with the customer service server program to control the embedded system controller and process the system customer service information;
wherein the system control interface executes transmitting/receiving of the system customer service information between the embedded system device and the customer service system according to a operational command from the computer executable interface/the customer service system.

2. The system of claim 1, wherein the host transmission interface and the device transmission interface are Universal Serial Bus (USB) interfaces.

3. The system of claim 1, wherein the embedded system device obtains the required electric power from the computer executable interface by connecting the host transmission interface and the device transmission interface.

4. The system of claim 1, wherein the system control interface further activates a self-analysis by downloading at least one plug-in component from the customer service server program.

5. The system of claim 1, wherein the system control interface further activates an real-time instant messaging procedure to communicate with the customer service system control interface according to the operational command.

6. The system of claim 1, wherein the system customer service information is one selected from the group consisting of product registration information, software version information, embedded system configuration information, embedded system record information, service actuating information, and customer service log information.

7. The system of claim 1, wherein the embedded system device further executes a self diagnosis procedure according to the operational command to generate and store embedded system configuration information in the memory.

8. A method of operating a customer service system of an embedded system device, comprising the following steps:
(a) connecting a device transmission interface of an embedded system device to a host transmission interface of a computer executable interface, so that the embedded system device is physically connected to the computer executable interface and generating a system control interface in the computer executable interface;
(b) driving a customer service client program of the embedded system device, and connecting a first network transmission interface of the computer executable interface to a second network transmission interface of a customer service system via the INTERNET; and
(c) receiving an operational command from the computer executable interface/the customer service system, and controlling an embedded system controller of the embedded system device and conducting transmission/reception of at least one system customer service information by executing a customer service client program of the embedded system device and a customer service server program of the customer service system.

9. The method of claim 8, wherein the step (a) further comprises a step of connecting the embedded system device and computer executable interface via Universal Serial Bus (USB) interface.

10. The method of claim 8, wherein the step (a) further comprises a step of downloading at least one plug-in component from the customer service server program when the system control interface is created.

11. The method of claim 8, wherein the step (a) further comprises a step of performing a self-diagnosis procedure by the plug-in components.

12. The method of claim 8, wherein the step (c) further comprises a step of activating an real-time instant messaging procedure according to the operational command and performing a instant messaging procedure between the system control interface and the customer service system control interface.

13. The method of claim 8, wherein the system customer service information is one selected from the group consisting of product registration information, software version information, embedded system configuration information, embedded system record information, service actuating information, and customer service log information.

14. The method of claim 8, wherein the step (c) further comprises a step of executing a self diagnosis procedure according to the operational command to generate and store the embedded system configuration information in a memory.

15. The method of claim 8, further comprises a step of tangibly connecting the host transmission interface to the device transmission interface and providing required electric power from the computer executable interface.

16. The method of claim 8, further comprises a step of storing the system customer service information in the memory of the embedded system device.

17. The method of claim 8, further comprises a step of connecting the computer executable interface to the customer service system and transmitting the product registration information to the customer service system to perform a product registration certification procedure.

18. The method of claim 17, wherein the product registration certification procedure further comprises a step of storing the product registration information in the customer service system.

19. The method of claim 8, further comprises a step of connecting the computer executable interface to the customer service system and transmitting the embedded system configuration information and the embedded system record information to the customer service system to execute an embedded system diagnosis procedure.

20. The method of claim 19, wherein the embedded system diagnosis procedure further comprises a step of updating the embedded system configuration information.
